(19) United States
(12) Patent Application Publication
(10) Pub. No.: US 2008/0129483 A1
(43) Pub. Date: Jun. 5, 2008

(54) Vehicle LED Lighting Apparatus and Operation Method of Same

(76) Inventor: Chia-Wen Wen, Pingtung County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/565,535

(22) Filed: Nov. 30, 2006

(51) Int. Cl. B60Q 1/26

(52) U.S. Cl. 340/468

(57) ABSTRACT

The evolutionary vehicle LED lighting apparatus is essentially formed of a power supply circuit for supplying the power to the apparatus, a microcomputer detecting and control unit, and a LED driving circuit installed at the output side of the power source. Upon detecting the power is on, the hardware built in the microcomputer detecting and control unit works to actuate the LED driving circuit so as to evolutionarily turn on the LEDS outwardly until, I all the LEDS are lit. Upon detecting the power is shut out, the microcomputer detecting and control unit actuates the LED driving circuit to turn off the LEDS in the reverse manner as they have been turned on thereby achieving the legibility and alarming effect of the vehicle lights rhythmically including both the brake light and the directional lights, also the operation method of this apparatus is disclosed.

### BACKGROUND OF THE INVENTION

1. Field of the Invention

The present invention relates to an evolutionary vehicle LED lighting apparatus and operation method of same. The operation of this apparatus allows the observer to improve the visual legibility and alarming effect of the vehicle brake light, and also to enjoy comfortable rhythmical feeling in operation of the brake light and LED directional light.

2. Description of the Prior Art

Recently, the application area of high intensity LED light has been extended widely to outdoor displays and traffic signals, and also to the automobile industry. Besides, it has achieved a marvelous success in portable electronic products such as cell phones, and backlights for PDA. LED is well known for its cold light low power consumption characteristic which is quite different from the traditional incandescent lamp. The other merits thereof such as long life, no loss of warming up time, rapid turning on ability, compact in size, anti-vibration (or relatively vibration-proof), easy for mass production, and suitable for grouping in a compact, matrix configuration. All of the above characteristics causes LED to play an important role in information, communication and consumer's electronic products including indication lamps and terminal displays.

There is a large need for lighting equipment in an average automobile which calls for more than 60 lamps for illuminating internal and external of a vehicle. Vehicle external lights include the front light for night use, the fog light for use in foggy weather condition, signal lights (include brake light direction indication light), and tail light. Also others are license light, decoration light, emergency light and the third brake light. As it is stated above the high intensity LED has the merits of rapid turning on, high reliability and long life so that it can improve traffic security as well as reduce vehicle maintenance cost. Early in the era of 1980s, LED had been employed as the third vehicle brake light.

Beginning from 1985, new sedans must equip a third brake light according to the US amended traffic law, and the application of this new law was extended to include station wagon and the coach limousine in 1991. In 1992, the General Electric Co. was the pioneer who installed 72 units of high intensity LED on the top edge of a truck. In spite of the fact that the US is the pioneer who used third vehicle brake light and applied high intensity LED as the light source of the third vehicle brake light, the US did not actively establish the related safety rules for the high intensity LED. And as a matter of fact, the manufacturers of automobile industry were not so active in promoting the market for LED by reason of rather expensive production cost. Thus, application of high intensity LED in the third vehicle brake light was confined in the field of luxurious cars.

The third brake light began to appear late in 1997 for the European automobile market. Owing to the fact that the development of light intensity LED is comparatively earlier in Europe than in any other area of the world, the high intensity LED has been employed by about 60% of the third vehicle brake light including middle class and a large sized vehicles such as coach limousines.

The third brake light on the present market is essentially a continuously flashing and thunder (or lightening, rather) type lights, and the original manufacturer's production has designated red as the defined color. Such kinds of brake light are turned on and turned off following the on-off movement of the brake pedal controlled by the driver's foot. The continuously flashing brake lights is realized by keeping the brake pedal in stepped state, and completely recover in turn off state when it is released. As for the thunder type, it is for decorative purposes. All of the aforesaid brake lights are in need of visual legibility and alarming effect for pedestrians and automobile drivers nearby, and at the rear side.

For these shortcomings on the prior art, an improvement is seriously required. In order to rectify these shortcomings, the applicant has dedicated great efforts for years to studying this matter, and finally has came up with this invention.

### SUMMARY OF THE INVENTION

Accordingly, the present invention is to provide an evolutionary vehicle LED lighting apparatus which is essentially formed of a power supply circuit for supplying power to the apparatus, a microcomputer detecting and control unit, and a LED driving circuit installed at the output side of the power source. Upon stepping on the brake pedal by the driver thereby turning the the power on, a hardware that is built in the microcomputer detecting and control unit works to actuate the LED driving circuit so as to evolutionarily turn on the LEDS outwardly one group after another with a time interval of some ten times of millisecond. Upon releasing of the brake pedal thereby turning the power off, the microcomputer detecting and control unit actuates the LED driving circuit to turn off the LEDS in the reverse manner as they have been turned on, thereby achieving the visual legibility and alarming effect of the vehicle lights rhythmically, including both brake light and directional lights. The operation method of this apparatus is also provided. The LED lights can be disposed in the configuration of long linear, spiral, and coaxial circular.

### BRIEF DESCRIPTION OF THE DRAWINGS

The drawings disclose an illustrative embodiment of the present invention that serves to exemplify the various advantages and objects hereof, and are as follows.

FIG. 1 is a block diagram of the present invention;

FIG. 2A is a resistance current limiting circuit layout diagram according to the present invention;

FIG. 2B is a current source circuit layout diagram according to the present invention;

FIG. 2C is a collaborated semiconductor driving circuit layout diagram according to the present invention;

FIG. 3 is an operational flow chart of the present invention; and

FIG. 4A to FIG. 4C are schematic views of four different types of arrangement for the LEDS in the evolutionary vehicle LED lighting apparatus in a long linear figure (FIG. 4A), spiral figure (FIG. 4B), and coaxial circular figure (Fig. C), according to the present invention.

### DETAILED DESCRIPTION OF THE PREFERRED EMBODIMENT

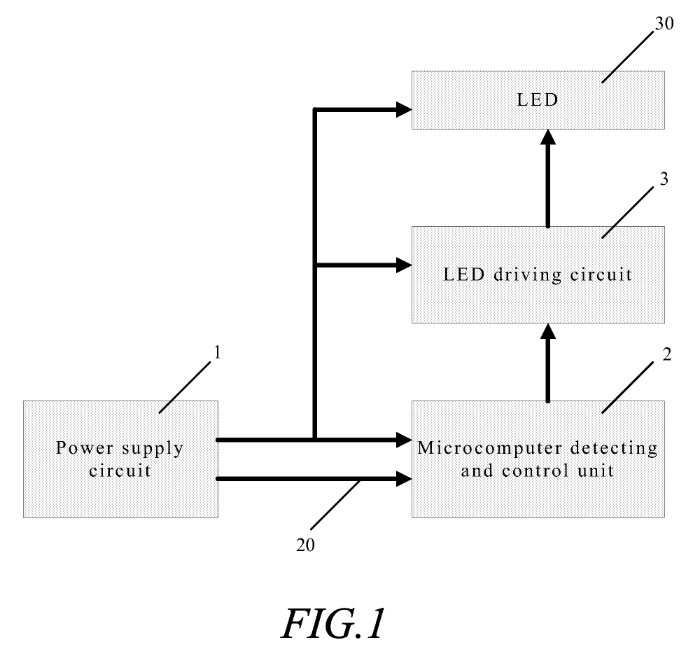

Referring to FIG. 1, As the system source voltage is built up in a power supply circuit 1, a power source signal 20 is detected by a microcomputer detecting and control unit 2. The hardware built in there works to actuate a LED driving circuit 3, which being installed at the output side of the power source, to evolutionarily turn on the LEDS 30 outwardly one group after another with a time interval of some ten times of millisecond.

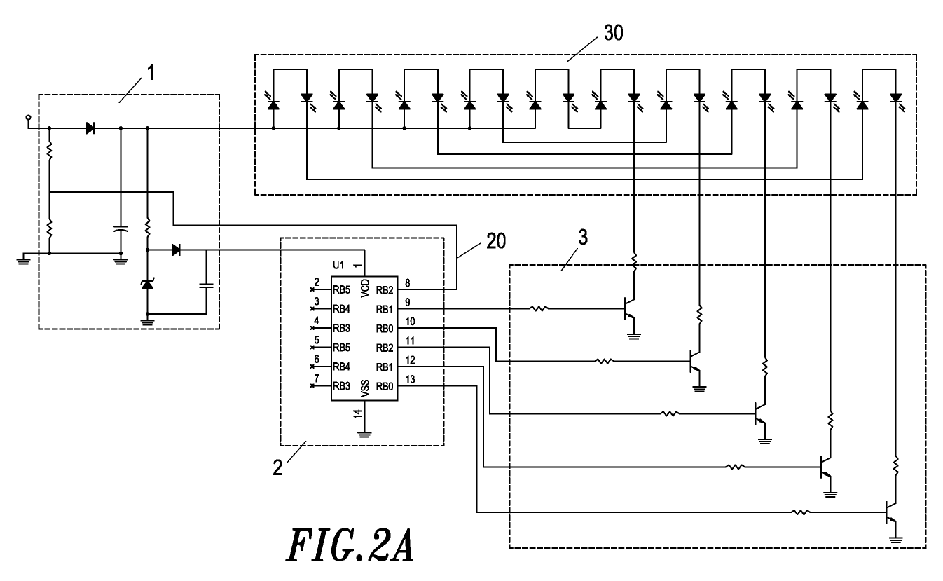

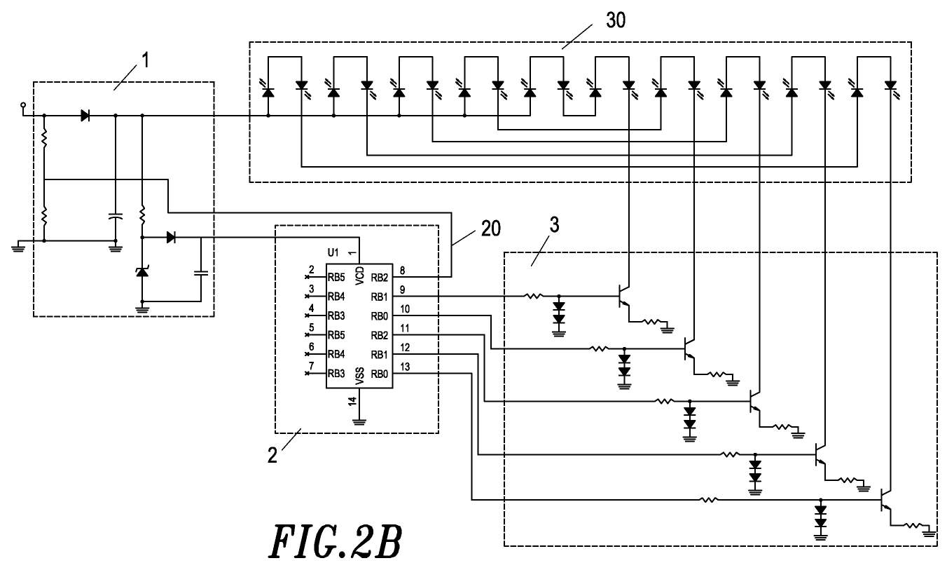

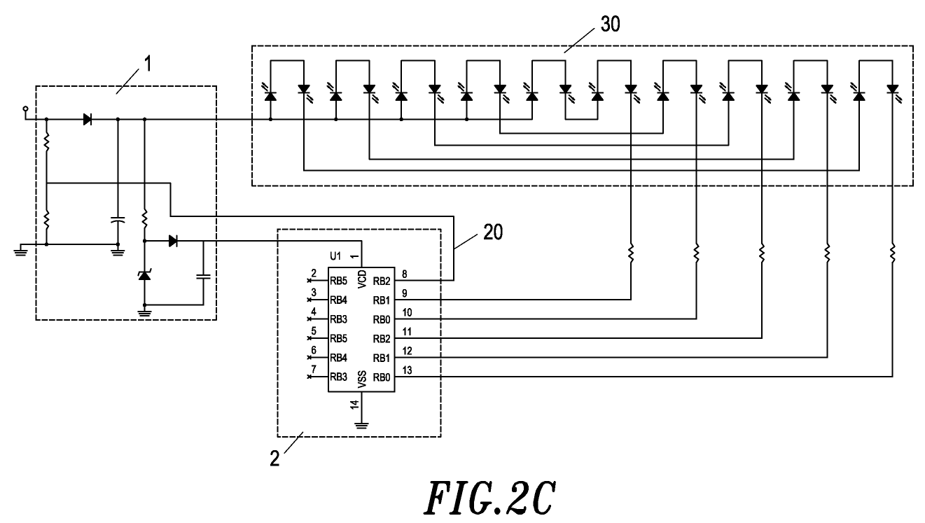

Referring to FIG. 2A, the Led driving circuit 3 is formed of a transistor circuit, the Led driving circuit 3 and the LEDS 30 can be combined in one group, or split into several groups according to actual requirement and design needs.

Referring to FIG. 2B, wherein the LED driving circuit 3 is composed of a transistor circuit, the LED driving circuit 3 and LEDS 30 can be combined in one group, or split into several groups according to actual requirement and design needs. The base voltage of transistor Q6 is 2.4V at the breakdown voltage of Zener diode D47 so that transistor Q6 produces an emitter voltage 2.4V−0.6V=1.8V. A resistance of 30Ω is connected from RPU6 to the ground so as to obtain a constant current 1.8V/30 Ω=60 mA, alternatively, Zener diode can be replaced by two same diodes connected forwardly in cascade.

The microcomputer detecting and control unit 2 is replaceable by a single component of equivalent function, and the LED driving circuit 3 is replaceable by an equivalent transistor circuit.

Referring to FIG. 2C, the LEDS 30 may be gathered in one group or divided in several groups and the microcomputer detecting and control unit 2 and the LED driving circuit 3 can be collaborated in one chip to operate with the same function thereby improving the visual legibility and alarming effect of the vehicle lights rhythmically, in both the brake light and the directional light.

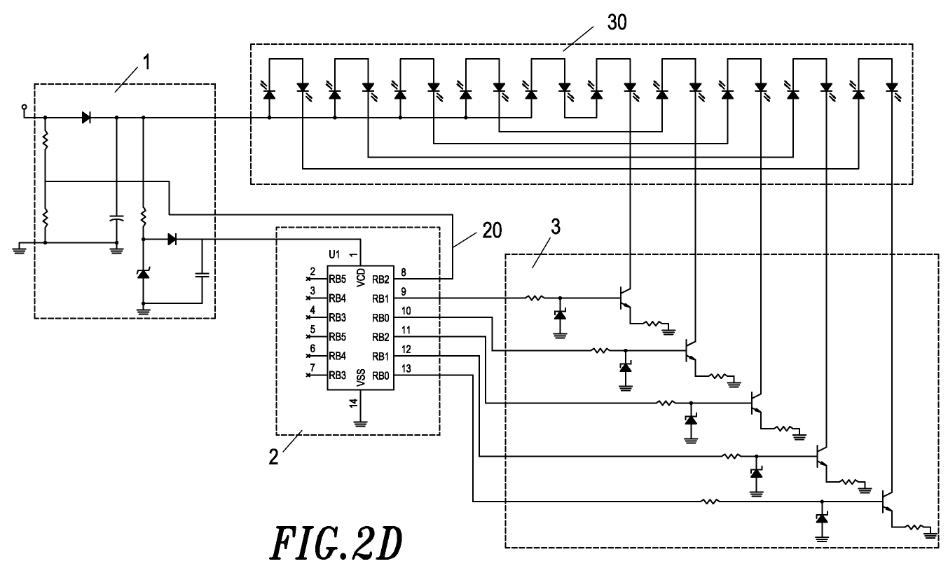

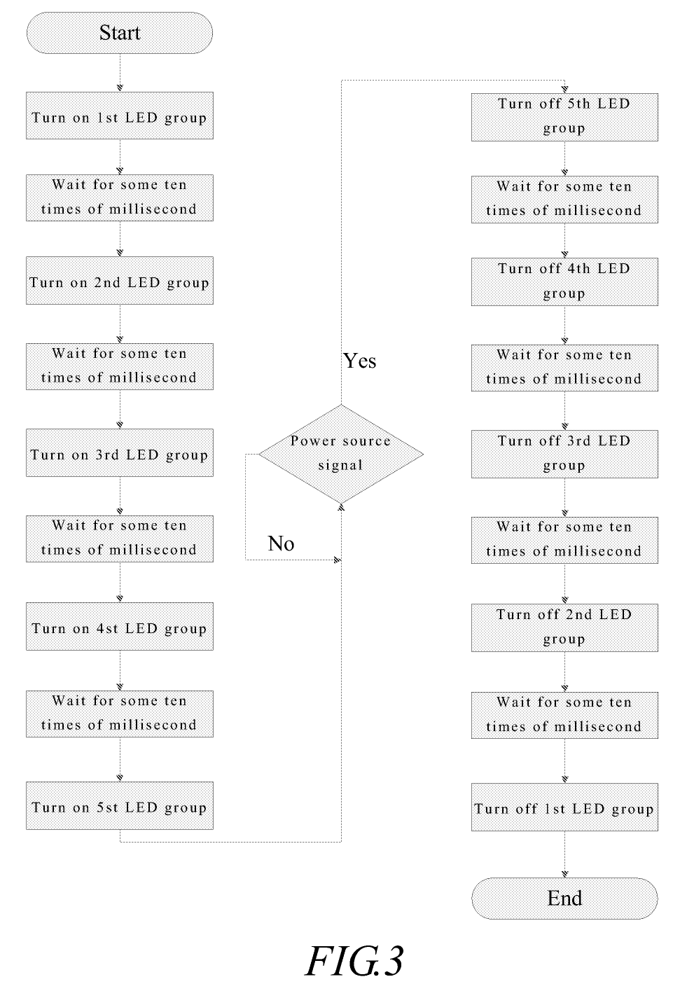

Referring to FIG. 3, the LEDS 30 are lit one by one up to the fifth group and then all of five groups of LEDS 30 are kept in turn-on state. As soon as the microcomputer detecting and control unit 2 has detected that the power source signal 20 is out, it actuates the LED driving circuit 3 to turn off the LEDS 30 in the reverse convergent manner as they have been turned on evolutionarily until all the LEDS 30 are turned off. The time intervals of turn on/off are adjusted and defined by a hardware built in the microcomputer detecting and control unit 2.

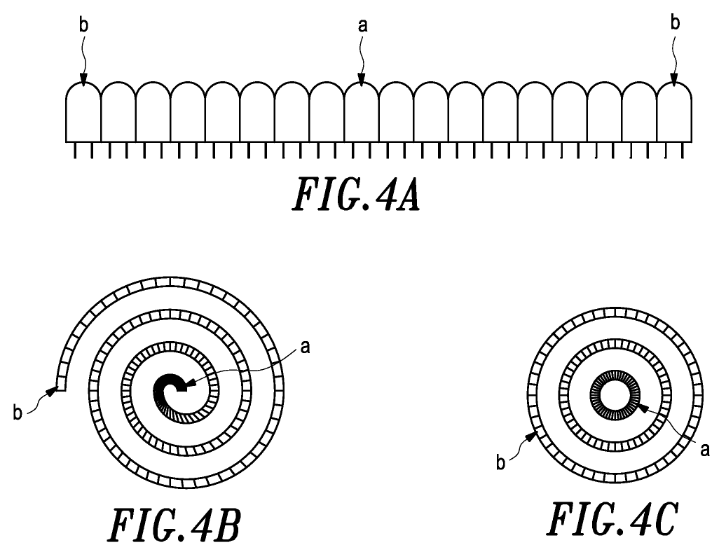

Referring to FIG. 4, the LEDS 30 of the present invention can be arranged in a long linear pattern (FIG. 4A), spiral pattern (FIG. 2B), and coaxial circular pattern (FIG. 4C) so as to evolutionarily turn on from point a to point b with the steps:

1. judging with the microcomputer detecting and control unit whether there is a power source signal;

2. if power is on, then turning on the LEDS 30 outwardly one group after another with a time interval of some ten times of millisecond until all LEDS 30 are lit; and

3. if the power is off, then convergently turning off the LEDS 30 inwardly one group after another with the same time interval as that they are turned on until all LEDS 30 are out.

In conclusion, evolutionary vehicle LED lighting apparatus of the present invention is able to evolutionarily turn on the LEDS of Brake light and directional lights outwardly until all the LEDS are lit, and convergently turn off the same LEDS in the reverse manner as they have been turned on thereby achieving the visual legibility and alarming effect of the vehicle lights in a rhythmic fashion.

Many changes and modifications above described embodiment of the invention can, of course, can be carried out without departing from the scope thereof. According, to promote the progress in science and the useful arts, the invention is disclosed and is intended to be limited only by the scope of the appended claims.

What we claimed is:

1. An vehicle LED lighting apparatus comprising:
a power supply circuit for applying electric power to said LED lighting apparatus;
a microcomputer detecting and control unit to detect a power source signal and actuate a LED driving circuit at the output terminal with a built in hardware;
said LED driving circuit for deciding turning on/off said LED according to said power source signal; and
a plurality of LEDS; wherein when the power is on, said LED driving circuit is actuated to evolutionarily turn on said LEDS outwardly one group after another until all said LEDS are lit, and when the power is out, said LED driving circuit is actuated to convergently turn off said LEDS inwardly one group after another until all said LEDS are out so as to achieve the visual legibility and alarming effect of the vehicle lights rhythmically including both the brake light and the directional lights.

2. The LED lighting apparatus of claim 1, wherein said microcomputer detecting and control unit is replaceable by a single component of equivalent function.

3. The LED lighting apparatus of claim 1, wherein said microcomputer detecting and control unit and said LED driving circuit can be collaborated in one chip to operate with the equivalent function.

4. The LED lighting apparatus of claim 1, wherein said LED driving circuit is replaceable by an equivalent transistor circuit.

5. The LED lighting apparatus of claim 1, wherein said LED driving circuit can be an equivalent circuit of any type.

6. The LED lighting apparatus of claim 1, wherein the Zener diode used in said Led driving circuit is replaceable with two same diodes connected forwardly in cascade.

7. The LED lighting apparatus of claim 1, wherein the number of said LED driving circuit is adjustable one or more than one according to the amount of said LEDS installed.

8. The LED lighting apparatus of claim 1, wherein said LEDS are arranged in a long linear pattern.

9. The LED lighting apparatus of claim 1, wherein said LEDS are arranged in a spiral pattern.

10. The LED lighting apparatus of claim 1, wherein said LEDS are arranged in a coaxial circular pattern.

11. The method of operating evolutionary vehicle LED lighting apparatus comprising the steps:
(1) judging by the microcomputer detecting and control unit whether there is the power source signal;
(2) if the power is on, then evolutionarily turning on the LEDS outwardly one group after another with a time interval of some ten times of millisecond until all the LEDS being lit; and
(3) if the power is off, then convergently turning off the LEDS inwardly one group after another with the same time interval as that they are turned on until all the LEDS being out.

12. The method of claim 11, wherein said time interval is prescribed by hardware built in said microcomputer detecting and control unit.
